(19) United States
(12) Patent Application Publication
(10) Pub. No.: US 2026/0168665 A1
(43) Pub. Date: Jun. 18, 2026

(54) ELECTRIC VACUUM SUCTION DEVICE

(71) Applicant: LIH YANN INDUSTRIAL CO., LTD., Taichung City (TW)

(72) Inventor: Po-Lin LIAO, Taichung City (TW)

(21) Appl. No.: 18/980,369

(22) Filed: Dec. 13, 2024

(51) Int. Cl. F21V 33/00; B25J 15/06; F21V 14/00; F21V 19/00; F21V 23/00; F21V 23/04

(52) U.S. Cl. CPC F21V 33/0084; B25J 15/0616; F21V 14/003; F21V 19/003; F21V 23/005; F21V 23/0442

(57) ABSTRACT

An electric vacuum suction device is provided, wherein the electric vacuum suction device includes: a cup member including a suction portion defining a chamber, a grip portion disposed on the suction portion, and an air evacuating mechanism configured to evacuate air from the chamber, the grip portion including a handle having first and second end portions, the first end portion including a first shell and a second shell which define a receiving space therebetween, the first shell including at least one light-penetrable portion; a backlight module mounted to the first shell and the second shell and positioned within the receiving space, the backlight module including at least one light-emitting unit, the at least one light-emitting unit being configured to emit light toward the at least one light-penetrable portion; and a panel including at least one display portion corresponding to the at least one light-penetrable portion.

### BACKGROUND OF THE INVENTION

### Field of the Invention

The present invention relates to a suction device, particularly to an electric vacuum suction device.

### Description of the Prior Art

During construction tasks, it is common to transport large, smooth and fragile objects such as glass or polished stone slabs. Due to their surface properties and fragility, these objects are often carried and moved using suction devices.

A conventional suction device, such as the electric vacuum suction device disclosed in Taiwan Patent No. M636125, features a control board electrically equipped with an indicator light and a power switch. The indicator light shows whether the power supply unit is providing electricity. However, the indicator light is directly exposed and emits light outward, providing in a monotonous color display.

The present invention is, therefore, arisen to obviate or at least mitigate the above-mentioned disadvantages.

### SUMMARY OF THE INVENTION

The main object of the present invention is to provide an electric vacuum suction device which delivers rich visual effects through a backlight module and when a user can directly observe the light emission state of its panel.

To achieve the above and other objects, an electric vacuum suction device is provided, wherein the electric vacuum suction device includes: a cup member including a suction portion, a grip portion and an air evacuating mechanism, the suction portion defining a chamber, the air evacuating mechanism being configured to evacuate air from the chamber such that the suction portion is configured to attach to an attachment surface, the grip portion being disposed on the suction portion, the grip portion including a handle, the handle having a first end portion and a second end portion opposite to each other, the first end portion including a first shell and a second shell, the first shell and the second shell defining a receiving space therebetween, the first shell including at least one light-penetrable portion; a backlight module mounted to the first shell and the second shell and positioned within the receiving space, the backlight module including at least one light-emitting unit, the at least one light-emitting unit being configured to emit light toward the at least one light-penetrable portion; and a panel including at least one display portion corresponding to the at least one light-penetrable portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is another exploded view of an exemplary embodiment of the present invention;

FIG. 4 is a partial exploded view of an exemplary embodiment of the present invention;

FIG. 5 is a partial enlarged view of an exemplary embodiment of the present invention.

FIG. 6 is yet another exploded view of an exemplary embodiment of the present invention;

FIG. 7 is a partial cross-sectional view of an exemplary embodiment of the present invention;

FIG. 8 is a schematic view showing the emission of a first light from an electric vacuum suction device of an exemplary embodiment of the present invention; and

FIG. 9 is a schematic view showing the emission of a second light from the electric vacuum suction device of an exemplary embodiment of the present invention.

### DETAILED DESCRIPTION OF THE PREFERRED EMBODIMENTS

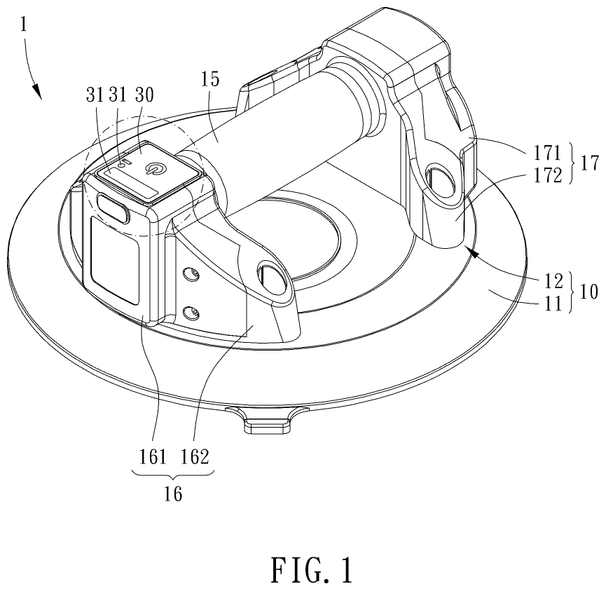

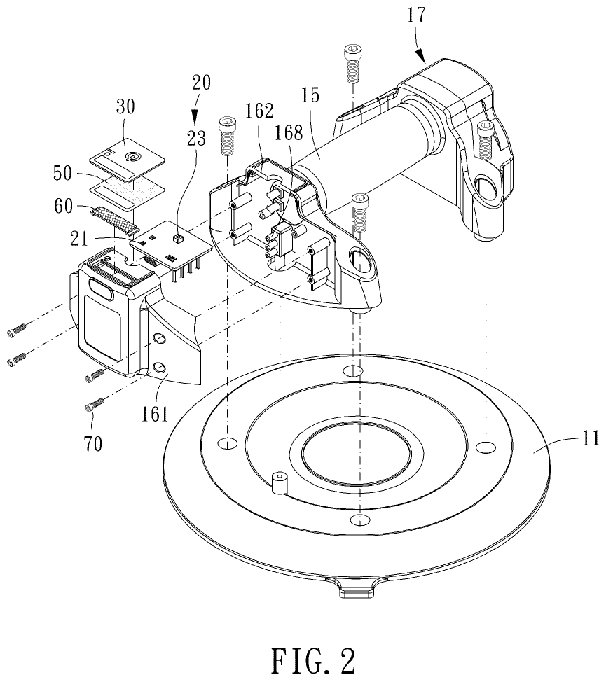

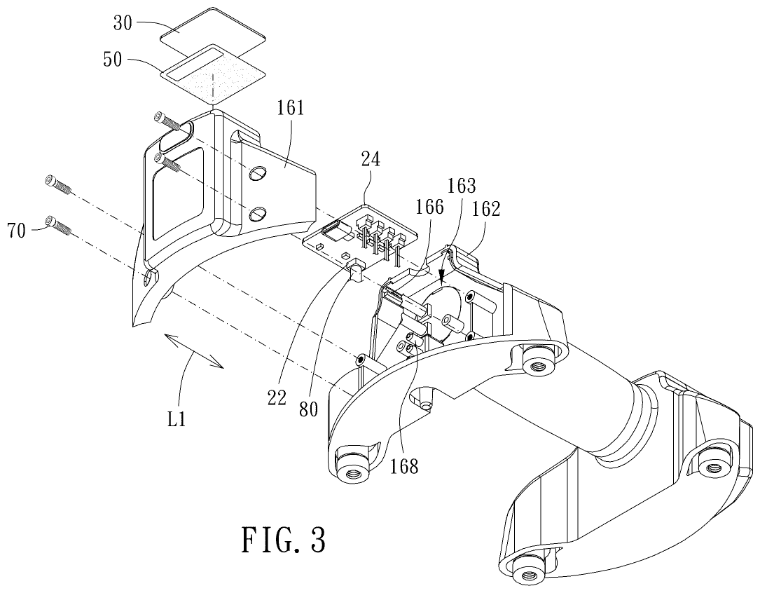

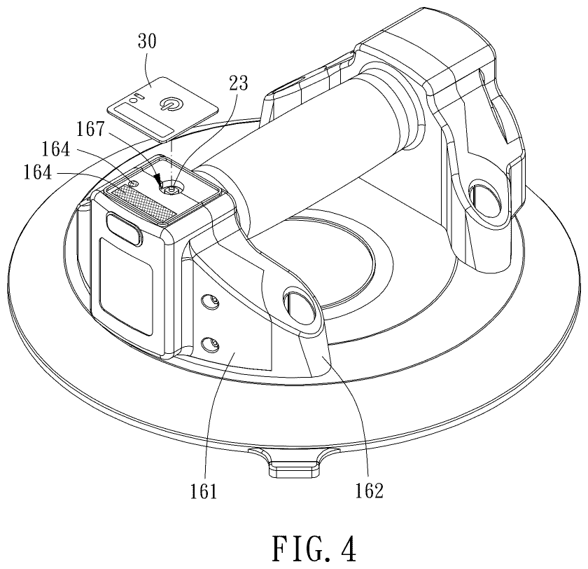

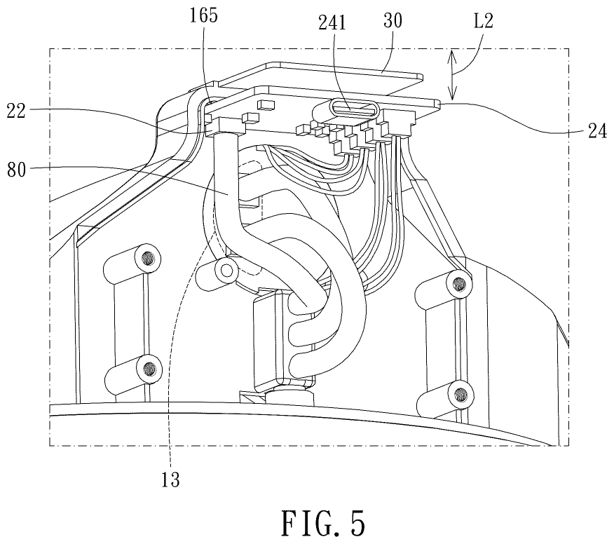

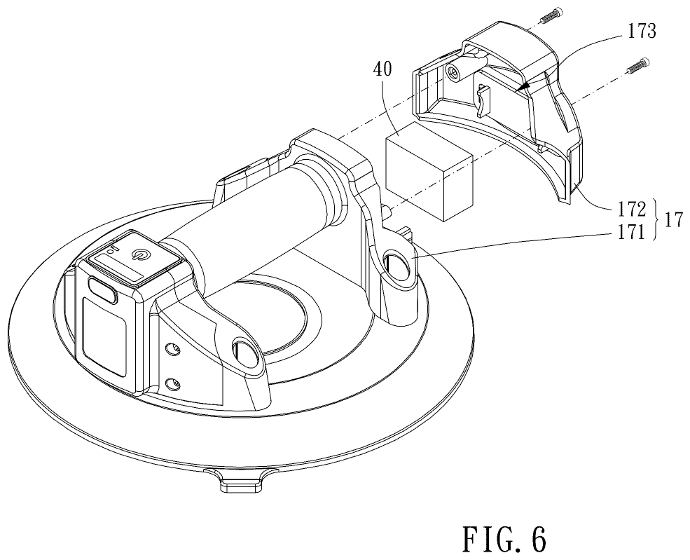

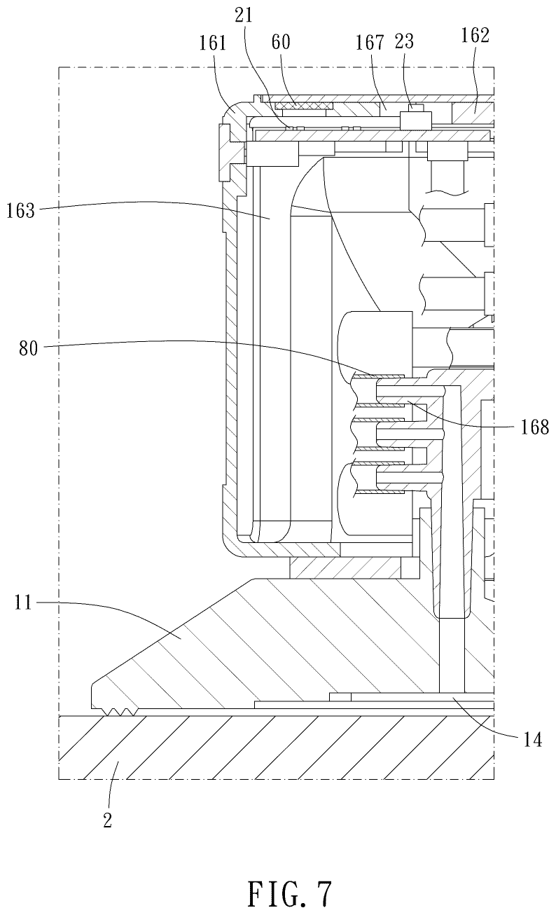

Please refer to FIGS. 1 to 9 for an exemplary embodiment of the present invention. An electric vacuum suction device 1 of the present invention includes a cup member 10, a backlight module 20, and a panel 30.

The cup member 10 includes a suction portion 11, a grip portion 12, and an air evacuating mechanism 13. The suction portion 11 defines a chamber 14, and the air evacuating mechanism 13 is configured to evacuate air from the chamber 14, enabling the suction portion 11 to attach to an attachment surface 2. In this embodiment, the air evacuating mechanism 13 is disposed on the grip portion 12 and in communication with the chamber 14 through passages on the grip portion 12 and the suction portion 11. The grip portion 12 is disposed on the suction portion 11 and includes a handle 15. The handle 15 has a first end portion 16 and a second end portion 17 opposite to each other. The first end portion 16 includes a first shell 161 and a second shell 162, and the first shell 161 and the second shell 162 define a receiving space 163 therebetween. The first shell 161 includes at least one light-penetrable portion 164. The grip portion 12 is detachably secured to the suction portion 11 using a plurality of fasteners 70. The backlight module 20 is mounted to the first shell 161 and the second shell 162 and positioned within the receiving space 163. The backlight module 20 includes at least one light-emitting unit 21, and the at least one light-emitting unit 21 is configured to emit light toward the at least one light-penetrable portion 164. The panel 30 includes at least one display portion 31 corresponding to the at least one light-penetrable portion 164. In this embodiment, the first shell 161 and the second shell 162 are detachably secured together by a plurality of fasteners 70.

Thus, when a hand grips the grip portion 12, it is convenient to observe the lighting state of each light-penetrable portion 164, and the backlight module 20 can present uniform light, providing an aesthetically pleasing visual effect. Furthermore, the backlight module 20 is mounted on the first shell 161 and the second shell 162. The backlight module 20 can have a larger size and remain stably positioned, facilitating its placement in either the first shell 161 or the second shell 162 when detached from the first shell 161, which is advantageous for maintenance and replacement.

In this embodiment, the panel 30 is a flexible liquid crystal panel. The direction, intensity and color of the presented light have significant effects, offering rich visual effects (such as light gradients, brightness intensity gradients, and variations in colors across different areas). Additionally, it can be tightly adhered to the first shell 161 and the second shell 162. An adhesive layer 50 is disposed on a side of the panel 30, and the panel 30 is adhered to the first shell 161 and the second shell 162 via the adhesive layer 50. The panel 30 with a large size can be used, and the adhesive layer 50 can further strengthen the adhesion between the first shell 161 and the second shell 162, making them less prone to separation. Preferably, the backlight module 20 further includes at least one prismatic lens 60. The at least one prismatic lens 60 is disposed on the at least one light-penetrable portion 164. The at least one light-penetrable portion 164 is hollow. In other embodiments, the at least one light-penetrable portion 164 may be made of light-transmitting material. The at least one prismatic lens 60 can be detachably engaged with the at least one light-penetrable portion 164 or fixedly adhered. The prismatic lenses 60 can enhance the visual layering of the light.

The backlight module 20 further includes a pressure sensing unit 22 and a control unit 23. The control unit 23 is electrically connected to the pressure sensing unit 22 and the at least one light-emitting unit 21. The pressure sensing unit 22 is configured to sense air pressure in the chamber 14 and transmit a pressure signal to the control unit 23. The control unit 23 controls the at least one light-emitting unit 21 to emit light based on the pressure signal.

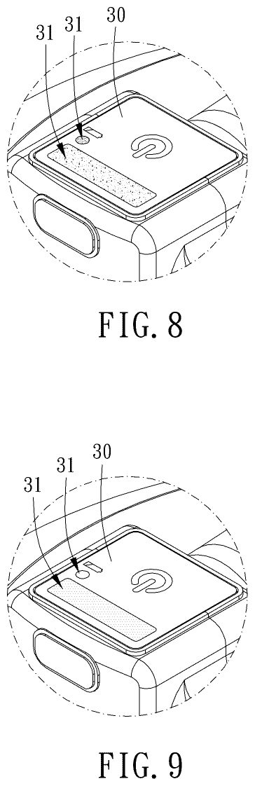

During use, when the control unit 23 determines that the pressure signal indicates a first pressure state (e.g., negative pressure during suction), the control unit 23 controls the at least one light-emitting unit 21 to emit a first light (e.g., green light, but not limited thereto), as shown in FIG. 8. When the control unit 23 determines that the pressure signal indicates a second pressure state (e.g., release of pressure during venting), the control unit 23 controls the at least one light-emitting unit 21 to emit a second light (e.g., red light, but not limited thereto), as shown in FIG. 9. The first light is different from the second light, and thus the pressure state within the chamber 14 can be determined based on the different light states or colors. In this embodiment, the second shell 162 includes an assembling portion 168 in communication with the chamber 14. The electric vacuum suction device 1 further includes a tubular member 80. The tubular member 80 is assembled with and in communication with the pressure sensing unit 22 and the assembling portion 168. This structure facilitates accurate sensing and regulation of pressure states. Preferably, the first shell 161 includes a plurality of the light-penetrable portions 164. The backlight module 20 includes a plurality of the light-emitting units 21. The plurality of the light-emitting units 21 correspond to the plurality of the light-penetrable portions 164. The panel 30 includes a plurality of the display portions 31. The plurality of the display portions 31 correspond to the plurality of the light-penetrable portions 164. Each of the light-emitting units 21 is a light-emitting diode. The plurality of the light-emitting units 21 can emit different or identical lights, enabling different lighting states to be displayed through the plurality of the light-penetrable portions 164 according to the pressure state.

The backlight module 20 further includes a circuit board 24. The control unit 23, each of the light-emitting units 21, and the pressure sensing unit 22 are disposed on the circuit board 24. The first shell 161 is assembled with the second shell 162 in a first direction L1. The first shell 161 includes a first slot 165 open in the first direction L1. The second shell 162 includes a second slot 166 corresponding to the first slot 165 and open in the first direction L1. The circuit board 24 is detachably engaged in the first slot 165 and the second slot 166. The circuit board 24 is spaced apart from the panel 30 in a second direction L2, and the first direction L1 is transverse to the second direction L2. This configuration facilitates easy assembly and disassembly for maintenance, while ensuring that the circuit board 24 is stably positioned within the first shell 161 and the second shell 162. The positioning also prevents electrical wires and pipes installed on the circuit board 24 and the second shell 162 from bending or detaching due to stress, achieving stable installation. Preferably, the first shell 161 and the second shell 162 form a through hole 167. The control unit 23 is exposed from the through hole 167. The control unit 23 can be operated by pressing the panel 30, enabling control of the air evacuating state of the air evacuating mechanism 13. In this embodiment, the control unit 23 is a button, but it is not limited thereto.

The electric vacuum suction device 1 further includes a power supply unit 40. The power supply unit 40 is a battery. The second end portion 17 includes a third shell 171 and a fourth shell 172. An installation space 173 is defined between the third shell 171 and the fourth shell 172. The power supply unit 40 is disposed in the installation space 173. The air evacuating mechanism 13 and the backlight module 20 are electrically connected to the power supply unit 40. Furthermore, the handle 15, the first end portion 16 and the second end portion 17 form a wiring channel, allowing the electrical wires of the air evacuating mechanism 13 and the backlight module 20 to be electrically connected to the power supply unit 40 through the wiring channel. This configuration hides the wires and isolates the power supply unit 40 from the backlight module 20, enabling independent maintenance, assembly, and disassembly.

The circuit board 24 further includes an electrical port 241. The electrical port 241 is electrically connected to each of the light-emitting units 21 and the control unit 23. An electrical connector (e.g., a USB Type-C connector) can be electrically connected to an external power source and plugged into the electrical port 241 to provide power.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electric vacuum suction device including:
a cup member including a suction portion, a grip portion and an air evacuating mechanism, the suction portion defining a chamber, the air evacuating mechanism being configured to evacuate air from the chamber such that the suction portion is configured to attach to an attachment surface, the grip portion being disposed on the suction portion, the grip portion including a handle, the handle having a first end portion and a second end portion opposite to each other, the first end portion including a first shell and a second shell, the first shell and the second shell defining a receiving space therebetween, the first shell including at least one light-penetrable portion;
a backlight module mounted to the first shell and the second shell and positioned within the receiving space, the backlight module including at least one light-emitting unit, the at least one light-emitting unit being configured to emit light toward the at least one light-penetrable portion; and
a panel including at least one display portion corresponding to the at least one light-penetrable portion.

2. The electric vacuum suction device of claim 1, wherein the backlight module further includes a pressure sensing unit and a control unit, the control unit being electrically connected to the pressure sensing unit and the at least one light-emitting unit, the pressure sensing unit is configured to sense air pressure in the chamber and transmit a pressure signal to the control unit, and the control unit is configured to control the at least one light-emitting unit to emit light according to the pressure signal.

3. The electric vacuum suction device of claim 2, wherein the control unit is configured to control the at least one light-emitting unit to emit a first light when the control unit determines that the pressure signal indicates a first pressure state, and to emit a second light when the control unit determines that the pressure signal indicates a second pressure state, and the first light is different from the second light.

4. The electric vacuum suction device of claim 2, wherein the backlight module further includes a circuit board, the control unit, the at least one light-emitting unit and the pressure sensing unit are disposed on the circuit board, the first shell is assembled with the second shell in a first direction, the first shell includes a first slot open in the first direction, the second shell includes a second slot corresponding to the first slot and open in the first direction, the circuit board is detachably engaged in the first slot and the second slot, the circuit board is spaced apart from the panel in a second direction, and the first direction is transverse to the second direction.

5. The electric vacuum suction device of claim 2, wherein the backlight module further includes a circuit board, the control unit is disposed on the circuit board, the first shell and the second shell form a through hole, and the control unit is exposed from the through hole.

6. The electric vacuum suction device of claim 1, further including a power supply unit, the second end portion includes a third shell and a fourth shell, the third shell and the fourth shell define an installation space therebetween, the power supply unit is disposed in the installation space, the air evacuating mechanism and the backlight module are electrically connected to the power supply unit.

7. The electric vacuum suction device of claim 1, wherein the panel is a flexible liquid crystal panel.

8. The electric vacuum suction device of claim 1, wherein an adhesive layer is disposed on a side of the panel, and the panel is adhered to the first shell and the second shell by the adhesive layer.

9. The electric vacuum suction device of claim 1, wherein the backlight module further includes at least one prismatic lens, the at least one prismatic lens is disposed on the at least one light-penetrable portion, and the at least one light-penetrable portion is hollow.

10. The electric vacuum suction device of claim 3, wherein the backlight module further includes a circuit board, the control unit, the at least one light-emitting unit and the pressure sensing unit are disposed on the circuit board, the first shell is assembled with the second shell in a first direction, the first shell includes a first slot open in the first direction, the second shell includes a second slot corresponding to the first slot and open in the first direction, the circuit board is detachably engaged in the first slot and the second slot, the circuit board is spaced apart from the panel in a second direction, and the first direction is transverse to the second direction; the first shell and the second shell form a through hole, and the control unit is exposed from the through hole; the electric vacuum suction device further includes a power supply unit, the second end portion includes a third shell and a fourth shell, the third shell and the fourth shell define an installation space therebetween, the power supply unit is disposed in the installation space, the air evacuating mechanism and the backlight module are electrically connected to the power supply unit; the panel is a flexible liquid crystal panel; an adhesive layer is disposed on a side of the panel, and the panel is adhered to the first shell and the second shell by the adhesive layer; the backlight module further includes at least one prismatic lens, the at least one prismatic lens is disposed on the at least one light-penetrable portion, and the at least one light-penetrable portion is hollow; the circuit board further includes an electrical port, and the electrical port is electrically connected to the at least one light-emitting unit and the control unit; the first shell and the second shell are detachably secured together by a plurality of fasteners; the second shell includes an assembling portion in communication with the chamber, the electric vacuum suction device further includes a tubular member, and the tubular member is assembled with and in communication with the pressure sensing unit and the assembling portion; the at least one light-penetrable portion includes a plurality of light-penetrable portions, the at least one light-emitting unit includes a plurality of light-emitting units, and the plurality of light-emitting units correspond to the plurality of light-penetrable portions.
